(19) United States
(12) Patent Application Publication
(10) Pub. No.: US 2026/0358503 A1
(43) Pub. Date: Nov. 12, 2026

(54) DISTANCE IMAGE CAPTURING SYSTEM, AND DISTANCE IMAGE CAPTURING METHOD

(71) Applicant: TOPPAN Holdings Inc., Tokyo (JP)

(72) Inventors: Shotaro SAIGUSA, Tokyo (JP); Yuya SHIRAKAWA, Tokyo (JP)

(73) Assignee: TOPPAN Holdings Inc., Tokyo (JP)

(21) Appl. No.: 19/668,163

(22) Filed: May 5, 2026

(30) Foreign Application Priority Data
May 12, 2025 (JP) 2025-079609

(51) Int. Cl. G01S 17/894; G01S 7/4865; G06T 5/50; G06T 7/33

(52) U.S. Cl. CPC G01S 17/894; G01S 7/4865; G06T 5/50; G06T 7/33; G06T 2207/10028; G06T 2207/20221

(57) ABSTRACT

A distance image capturing system includes: a plurality of distance image capturing devices arranged such that angles of view thereof partially overlap each other, each of the plurality of distance image capturing devices including a light source unit, and a light receiving unit in which a plurality of pixels are arranged, each pixel having a photoelectric conversion element, each of the plurality of distance image capturing devices being configured to output an optical image , and a distance image; and a synthesis processing unit configured to synthesize the optical images and the distance images, in which the synthesis processing unit is configured to compare pixel values of overlapping pixels in an overlapping region in which the angles of view partially overlap each other, select a pixel having a pixel value estimated to be optimal, and perform synthesis using a value based on the selected pixel.

### BACKGROUND OF THE INVENTION

### Field of the Invention

The present invention relates to a distance image capturing system, and a distance image capturing method.

Priority is claimed on Japanese Patent Application No. 2025-079609, filed May 12, 2025, the content of which is incorporated herein by reference.

### Description of Related Art

In recent years, logistics problems caused by labor shortages have become an urgent social issue, and automation by robots, which is key to the growth of logistics DX, requires a time-of-flight (Time of Flight; hereinafter referred to as “TOF”) distance image capturing device that can be used under various environments and whose performance-to-price ratio matches market needs.

In a case where a TOF distance image capturing device is mounted on a robot or the like, it is important to capture a wide range at once, and a technique of synthesizing images captured by a plurality of distance image capturing devices to expand a field of view (FOV) is known (for example, see Patent Document 1 (Japanese Unexamined Patent Application No. 2021-148746)).

### SUMMARY OF THE INVENTION

In the related art disclosed in Patent Document 1, for example, a method of taking an average of a plurality of images is used for a synthesized portion of images acquired from a plurality of TOF distance image capturing devices. However, in such a related art, for example, in a case where there is a difference in acquired images due to individual differences of the distance image capturing devices or the plurality of distance image capturing devices perform different operations (for example, a difference in exposure time), there is a possibility that an optimal image of an overlapping portion of the angles of view is not output.

The present invention has been made to solve the above problems, and an object of the present invention is to provide a distance image capturing system, and a distance image capturing method capable of outputting an optimal image of an overlapping portion of the angles of view and capable of outputting a wide-range image at once.

In order to achieve the above object, an aspect of the present invention relates to a distance image capturing system including: a plurality of distance image capturing devices arranged such that angles of view thereof partially overlap each other, each of the plurality of distance image capturing devices including a light source unit configured to irradiate a subject with optical pulses, and a light receiving unit in which a plurality of pixels are arranged, each of the pixels having a photoelectric conversion element configured to generate a charge in accordance with reflected light of the optical pulses from the subject, each of the plurality of distance image capturing devices being configured to output optical images based on pixel values that are values of the pixels based on the charges, and distance images calculated based on a period from irradiation with the optical pulses to reception of the reflected light; and a synthesis processing unit configured to synthesize the optical images and the distance images output from the plurality of distance image capturing devices, in which the synthesis processing unit is configured to compare pixel values of overlapping pixels in an overlapping region in which the angles of view partially overlap each other, select a pixel having a pixel value estimated to be optimal, and perform synthesis using a value based on the selected pixel.

In addition, another aspect of the present invention relates to a distance image capturing method including: an imaging step of, via a plurality of distance image capturing devices arranged such that angles of view thereof partially overlap each other, each of the plurality of distance image capturing devices including a light source unit configured to irradiate a subject with optical pulses, and a light receiving unit in which a plurality of pixels are arranged, each of the pixels having a photoelectric conversion element configured to generate a charge in accordance with reflected light of the optical pulses from the subject, outputting optical images based on pixel values that are values of the pixels based on the charges, and distance images calculated based on a period from irradiation with the optical pulses to reception of the reflected light; and a synthesis processing step of, via a synthesis processing unit, synthesizing the optical images and the distance images output from the plurality of distance image capturing devices, in which, in the synthesis processing step, the synthesis processing unit compares pixel values of overlapping pixels in an overlapping region in which the angles of view partially overlap each other, selects a pixel having a pixel value estimated to be optimal, and performs synthesis using a value of the selected pixel.

In addition, still another aspect of the present invention relates to a program causing a computer to execute a process including: an acquisition step of, from a plurality of distance image capturing devices arranged such that angles of view thereof partially overlap each other, each of the plurality of distance image capturing devices including a light source unit configured to irradiate a subject with optical pulses, and a light receiving unit in which a plurality of pixels are arranged, each pixel having a photoelectric conversion element configured to generate a charge in accordance with reflected light of the optical pulses from the subject, acquiring an optical image based on pixel values that are values of the pixels based on the charges, and a distance image calculated based on a period from irradiation with the optical pulses to reception of the reflected light; and a synthesis processing step of synthesizing the optical images and the distance images acquired from the plurality of distance image capturing devices, in which pixel values of overlapping pixels are compared in an overlapping region in which the angles of view partially overlap each other, a pixel having a pixel value estimated to be optimal is selected, and synthesis is performed using a value of the selected pixel.

According to the present invention, it is possible to output the optimal image of the overlapping portion of the angles of view and to output the wide-range image at once.

### BRIEF DESCRIPTION OF THE DRAWINGS

FIG. 1 is a block diagram showing an example of a distance image capturing system according to a first embodiment.

FIG. 2 is a block diagram showing an example of a TOF camera according to the first embodiment.

FIG. 3 is a diagram showing an example of image synthesis processing of the distance image capturing system according to the first embodiment.

FIG. 4 is a flowchart showing an example of the image synthesis processing of the distance image capturing system according to the first embodiment.

FIG. 5 is a first flowchart showing an example of image synthesis processing of a distance image capturing system according to a second embodiment.

FIG. 6 is a second flowchart showing an example of the image synthesis processing of the distance image capturing system according to the second embodiment.

FIG. 7 is a first diagram showing an example of exception processing in the image synthesis processing of IR images of the distance image capturing system according to the second embodiment.

FIG. 8 is a second diagram showing an example of exception processing in the image synthesis processing of IR images of the distance image capturing system according to the second embodiment.

FIG. 9 is a first diagram showing an example of the image synthesis processing of distance images of the distance image capturing system according to the second embodiment.

FIG. 10 is a second diagram showing an example of the image synthesis processing of distance images of the distance image capturing system according to the second embodiment.

### DETAILED DESCRIPTION OF THE INVENTION

Hereinafter, a distance image capturing system and a distance image capturing method according to embodiments of the present invention will be described with reference to the accompanying drawings.

### First Embodiment

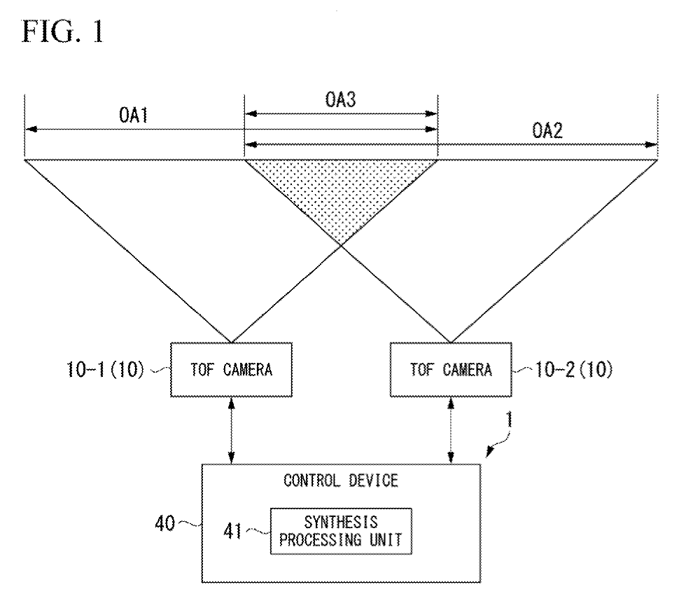

FIG. 1 is a block diagram showing an example of a distance image capturing system 1 according to the present embodiment. As shown in FIG. 1, the distance image capturing system 1 includes a plurality of TOF cameras 10 (10-1 and 10-2) and a control device 40.

The TOF camera 10 is a TOF distance image capturing device, and outputs an infrared (IR) image (an example of an optical image) that is an image of IR rays and a distance image that is an image of a distance to a subject. In the present embodiment, an example will be described in which the distance image capturing system 1 includes two TOF cameras 10.

In the present embodiment, the TOF camera 10-1 and the TOF camera 10-2 have the same configuration, such that the TOF cameras will be referred to as the TOF camera 10. In addition, in a case of referring any TOF camera included in the distance image capturing system 1 or in a case of not distinguishing the TOF camera 10-1 and the TOF camera 10-2, the TOF cameras will be referred to as the TOF camera 10.

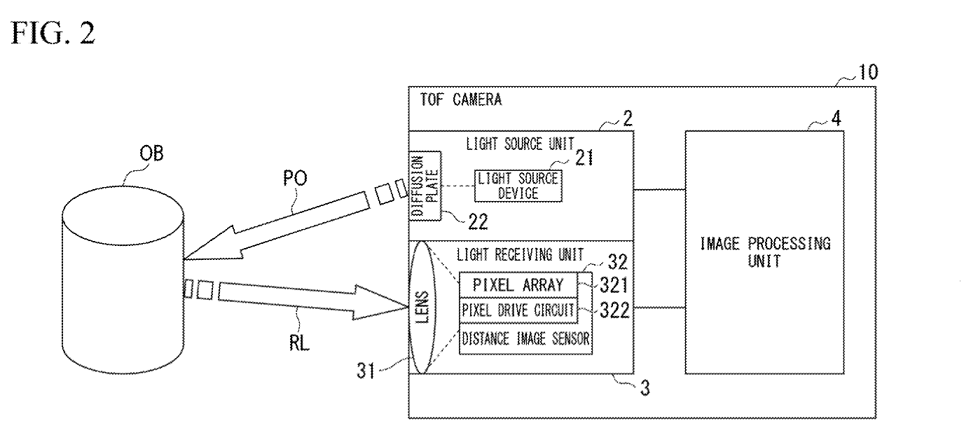

Here, the configuration example of the TOF camera 10 will be described with reference to FIG. 2.

FIG. 2 is a block diagram showing an example of the TOF camera 10 according to the present embodiment.

As shown in FIG. 2, the TOF camera 10 includes a light source unit 2, a light receiving unit 3, and an image processing unit 4. FIG. 2 also shows a subject OB that is a target object for which the distance is measured using the TOF camera 10.

The light source unit 2 irradiates an imaging target space, in which the subject OB that is a target for which the distance is measured in the TOF camera 10 is present, with optical pulses PO in accordance with control from the image processing unit 4. The light source unit 2 is, for example, a surface-emitting semiconductor laser module such as a vertical cavity surface emitting laser (VCSEL).

Further, the light source unit 2 includes a light source device 21 and a diffusion plate 22.

The light source device 21 is a light source that emits laser light, in a near-infrared wavelength range (for example, a wavelength range of 850 nm to 940 nm), that is the optical pulses PO with which the subject OB is irradiated. The light source device 21 is, for example, a semiconductor laser light-emitting element. The light source device 21 emits pulsed laser light in accordance with control from a measurement control unit 43.

The diffusion plate 22 is an optical component that diffuses the laser light in the near-infrared wavelength range emitted by the light source device 21 to a size corresponding to a surface for irradiating the subject OB. The pulsed laser light diffused by the diffusion plate 22 is emitted as the optical pulse PO and irradiates the subject OB.

The light receiving unit 3 receives reflected light RL of the optical pulse PO reflected by the subject OB, which is a target for which the distance is measured by the TOF camera 10, and outputs a pixel signal corresponding to the received reflected light RL. The light receiving unit 3 includes a lens 31 and a distance image sensor 32.

The lens 31 is an optical lens that guides the incident reflected light RL to the distance image sensor 32. The lens 31 emits the incident reflected light RL toward the distance image sensor 32 and causes the reflected light RL to be received (incident) on a pixel array 321 provided in a light reception region of the distance image sensor 32.

The distance image sensor 32 is an imaging element used in the TOF camera 10. The distance image sensor 32 includes the pixel array 321 in which a plurality of pixels are arranged in a two-dimensional light reception region, and a pixel drive circuit 322 that controls each of the pixels.

Each pixel in the pixel array 321 in the two-dimensional light reception region is provided with one photoelectric conversion element, a charge accumulation unit (for example, a plurality of charge accumulation units) corresponding to the one photoelectric conversion element, and a component that distributes the charges to each charge accumulation unit.

A plurality of pixels are arranged in the pixel array 321 in a two-dimensional matrix, and each pixel accumulates the charges corresponding to the amount of received light.

The pixel drive circuit 322 accumulates the charges generated in the photoelectric conversion element in the charge accumulation unit in synchronization with the irradiation with the optical pulse PO in a frame cycle under the control of the image processing unit 4. In one frame, the irradiation with a plurality of optical pulses is performed. In addition, the pixel drive circuit 322 outputs pixel signals corresponding to the charges accumulated in the charge accumulation unit to the image processing unit 4.

The image processing unit 4 outputs a distance image calculated based on a period from the irradiation with the optical pulse PO to the reception of the reflected light RL, and the IR image based on pixel values that are values of the pixels based on the charges converted by the photoelectric conversion elements.

The image processing unit 4 controls the TOF camera 10 to calculate the distance to the subject OB. The image processing unit 4 calculates the distance for each pixel based on a period from the irradiation with the optical pulse PO to the reception of the reflected light RL, and generates the distance image.

In addition, the image processing unit 4 acquires the pixel value of each pixel, and generates the IR image based on the pixel values.

Returning to the description of FIG. 1, two TOF cameras 10 (10-1 and 10-2) are disposed such that the angles of view partially overlap each other.

In FIG. 1, an angle of view OA1 indicates the angle of view of the TOF camera 10-1 (first distance image capturing device), and an angle of view OA2 indicates the angle of view of the TOF camera 10-2 (second distance image capturing device). In addition, an overlapping region OA3 indicates a region in which the angle of view OA1 and the angle of view OA2 overlap, and is a region in which the angles of view partially overlap each other.

The TOF camera 10-1 generates the IR image and the distance image in a range of the angle of view OA1 under the control of the control device 40, and outputs the IR image and the distance image in a range of the angle of view OA1 to the control device 40.

In addition, the TOF camera 10-2 generates the IR image and the distance image in a range of the angle of view OA2 under the control of the control device 40, and outputs the IR image and the distance image in the range of the angle of view OA2 to the control device 40.

The control device 40 is, for example, a computer device such as a personal computer. The control device 40 is a functional unit that is implemented by causing a processor including a central processing unit (CPU) to execute a program stored in a storage unit (not shown), and comprehensively controls the distance image capturing system 1.

The control device 40 controls the two TOF cameras 10 to acquire the IR image and the distance image in the range of the angle of view OA1, and the IR image and the distance image in the range of the angle of view OA2. In addition, the control device 40 synthesizes the IR image in the range of the angle of view OA1 and the IR image in the range of the angle of view OA2 to generate a composite IR image. In addition, the control device 40 synthesizes the distance image in the range of the angle of view OA1 and the distance image in the range of the angle of view OA2 to generate a composite distance image.

Further, the control device 40 includes a synthesis processing unit 41.

The synthesis processing unit 41 synthesizes the IR images and the distance images output by the plurality of (for example, two) TOF cameras 10 to generate the composite IR image and the composite distance image. The synthesis processing unit 41 compares the pixel values of the overlapping pixels in, for example, a region (overlapping region OA3) in which the angles of view partially overlap each other, selects a pixel having a pixel value estimated to be optimal, and performs synthesis using the value based on the selected pixel.

Specifically, the synthesis processing unit 41 compares the pixel values of the overlapping pixels, and selects a pixel having the largest pixel value (in a case of the two TOF cameras 10, a pixel having a larger pixel value) as the pixel having the pixel value estimated to be optimal. The synthesis processing unit 41 synthesizes the IR images using the pixel value of the selected pixel in the overlapping region (overlapping region OA3). Further, the synthesis processing unit 41 synthesizes the distance images using the distance of the pixel selected using the pixel value in the overlapping region (overlapping region OA3).

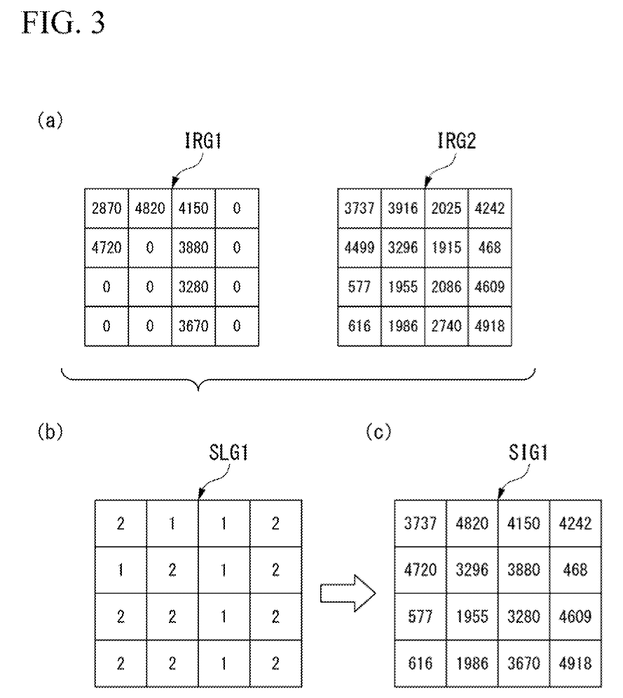

Here, a specific example of the synthesis processing of the IR images will be described with reference to FIG. 3.

FIG. 3 is a diagram showing an example of image synthesis processing of the distance image capturing system 1 according to the present embodiment.

In (a) of FIG. 3, an IR image IRG1 is an overlapping region (overlapping region OA3) of the IR image captured by the TOF camera 10-1. Further, an IR image IRG2 is an overlapping region (overlapping region OA3) of the IR image captured by the TOF camera 10-2.

In addition, a selected pixel SLG1 shown in (b) of FIG. 3 indicates whether the pixel of the TOF camera 10-1 or the TOF camera 10-2 is selected in the overlapping region (overlapping region OA3) of the IR image. In the selected pixel SLG1, "1" is described when the pixel of the TOF camera 10-1 is selected, and "2" is described when the pixel of the TOF camera 10-2 is selected.

The synthesis processing unit 41 compares the pixel values of the respective pixels of the IR image IRG1 and the IR image IRG2 shown in (a) of FIG. 3, and selects a pixel having a larger pixel value as in the selected pixel SLG1 shown in (b) of FIG. 3.

In addition, a composite IR image SIG1 shown in (c) of FIG. 3 shows a composite IR image synthesized using the pixel selected in (b) of FIG. 3 in the overlapping region (overlapping region OA3) of the IR image. As shown in (c) of FIG. 3, the synthesis processing unit 41 generates the composite IR image SIG1 using the pixel selected in (b) of FIG. 3.

As described above, in the present embodiment, the synthesis processing unit 41 compares the pixel values for the respective pixels, and selects the pixel having the pixel value estimated to be optimal (a pixel having a larger pixel value) to generate the composite IR image.

Further, the synthesis processing unit 41 also synthesizes the distance images using the pixel selected in (b) of FIG. 3 to generate a composite distance image.

Next, an operation of the distance image capturing system 1 according to the present embodiment will be described with reference to the accompanying drawings.

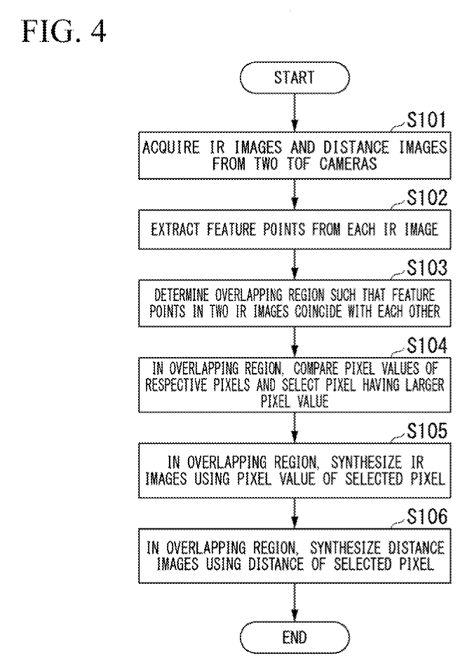

FIG. 4 is a flowchart showing an example of the image synthesis processing of the distance image capturing system 1 according to the present embodiment.

As shown in FIG. 4, the control device 40 of the distance image capturing system 1 first acquires the IR images and the distance images from the two TOF cameras 10 (10-1 and 10-2) (step S101). That is, the synthesis processing unit 41 of the control device 40 acquires the IR image and the distance image from each of the TOF camera 10-1 and the TOF camera 10-2.

Next, the synthesis processing unit 41 extracts feature points from each IR image (step S102). Here, the feature point indicates, for example, a point that is particularly noticeable or important in the image, and examples thereof include a change in edge, corner, or texture of an object included in the IR image.

Next, the synthesis processing unit 41 determines the overlapping region (for example, the overlapping region OA3) such that the feature points coincide with each other in the two IR images (step S103). The synthesis processing unit 41 performs matching such that the feature points coincide with each other, and performs recognition and alignment of the object in the overlapping region OA3.

Next, the synthesis processing unit 41 compares the pixel values of the respective pixels in the overlapping region OA3, and selects a pixel having a larger pixel value (step S104). In a case where three or more IR images are synthesized, the synthesis processing unit 41 selects a pixel having the largest pixel value as the pixel having the pixel value estimated to be optimal.

Next, the synthesis processing unit 41 synthesizes the IR images using the pixel value of the selected pixel in the overlapping region OA3 (step S105). The synthesis processing unit 41 synthesizes the IR images using the pixel value of the selected pixel to generate, for example, the composite IR image synthesized in the range of the angle of view OA1 and the angle of view OA2.

Then, the synthesis processing unit 41 synthesizes the distance images using the distance of the selected pixel in the overlapping region OA3 (step S106). The synthesis processing unit 41 synthesizes the distance images using the distance of the selected pixel to generate, for example, the composite distance image synthesized in the range of the angle of view OA1 and the angle of view OA2. After the processing of step S106, the synthesis processing unit 41 ends the processing.

In the flowchart shown in FIG. 4 described above, the processing of step S101 corresponds to an acquisition step of acquiring the IR image (optical image) and the distance image from the plurality of TOF cameras 10 arranged such that the angles of view partially overlap each other.

As described above, the distance image capturing system 1 according to the present embodiment includes the plurality of (for example, two) TOF cameras 10 (distance image capturing devices) and the synthesis processing unit 41. The plurality of (for example, two) TOF cameras 10 (distance image capturing devices) each include the light source unit 2 and the light receiving unit 3, and output the optical images based on the pixel values that are the values of the pixels based on the charges, and the distance images calculated based on the period from the irradiation with the optical pulse PO to the light reception of the reflected light RL. The plurality of (for example, two) TOF cameras 10 are arranged such that the angles of view partially overlap each other. The synthesis processing unit 41 synthesizes the IR image (optical image) and the distance image output by the plurality of (for example, two) TOF cameras 10. The synthesis processing unit 41 compares the pixel values of the overlapping pixels in a region (for example, overlapping region OA3) in which the angles of view partially overlap each other, selects a pixel having a pixel value estimated to be optimal, and performs synthesis using the value based on the selected pixel.

As a result, the distance image capturing system 1 according to the present embodiment compares the pixel values of the overlapping pixels in units of pixels, selects the pixel of the pixel value estimated to be optimal, and synthesizes the pixel values using the value of the selected pixel, so that the optimal image of the overlapping portion of the angles of view can be output, and a wide-range image can be output at once.

Further, in the present embodiment, the synthesis processing unit 41 compares the pixel values of the overlapping pixels, and selects the pixel having the largest pixel value as the pixel of the pixel value estimated to be optimal.

As a result, the distance image capturing system 1 according to the present embodiment selects the pixel having the largest pixel value, so that the influence of noise can be reduced, and thus the composite IR image and the composite distance image with less noise can be obtained.

Further, in the present embodiment, the synthesis processing unit 41 synthesizes the IR images using the pixel value of the selected pixel in the overlapping region (for example, the overlapping region OA3), and synthesizes the distance images using the distance of the selected pixel by comparing the pixel values.

As a result, the distance image capturing system 1 according to the present embodiment can reduce noise in the distance measurement by using the pixel having a larger pixel value of the IR image.

In addition, the distance image capturing system 1 according to the present embodiment can generate an appropriate composite distance image by using the pixel having a larger pixel value of the IR image, for example, even in a case where the operations are different, such as different exposure times in the two TOF cameras 10. That is, the distance image capturing system 1 according to the present embodiment can appropriately respond to, for example, a case where objects having different reflectances are present within the angles of view of the adjacent TOF cameras 10, a case where the distances of the target objects are different, and the like.

In addition, in the present embodiment, the synthesis processing unit 41 extracts the feature points from each of the optical images output by the plurality of TOF cameras 10, and determines the synthesis position of the optical images such that the extracted feature points coincide with each other.

As a result, the distance image capturing system 1 according to the present embodiment can more accurately determine the region (for example, the overlapping region OA3) in which the angles of view partially overlap each other between the two TOF cameras 10, and can output a more optimal image of the overlapping portion of the angles of view.

In addition, in the present embodiment, the region in which the angles of view partially overlap each other (for example, the overlapping region OA3) is a region in which the angles of view (the angle of view OA1 and the angle of view OA2) of the two TOF cameras 10 (10-1 and 10-2) partially overlap each other.

As a result, the distance image capturing system 1 according to the present embodiment can output an optimal image of the overlapping portion of the angles of view by using the two TOF cameras 10 (10-1 and 10-2), and can output a wide-range image at once.

In addition, the distance image capturing method according to the present embodiment includes an imaging step and a synthesis processing step. In the imaging step, each of the plurality of TOF cameras 10 arranged such that the angles of view partially overlap each other outputs the optical image based on the pixel values that are the values of the pixels based on the charges, and the distance image calculated based on the period from the irradiation with the optical pulse PO to the reception of the reflected light RL. The TOF camera 10 includes the light source unit 2 that irradiates the subject OB with the optical pulse PO, and the light receiving unit 3 in which a plurality of pixels each having a photoelectric conversion element that generates a charge in accordance with the reflected light RL of the optical pulse PO from the subject OB are arranged. In the synthesis processing step, the synthesis processing unit 41 synthesizes the optical images and the distance images output by the plurality of TOF cameras 10. In addition, in the synthesis processing step, the synthesis processing unit 41 compares the pixel values of the overlapping pixels in the region in which the angles of view partially overlap each other, selects the pixel of the pixel value estimated to be optimal, and synthesizes the images using the value of the selected pixel.

As a result, the distance image capturing method according to the present embodiment has the same effects as the distance image capturing system 1 described above, can output an optimal image of the overlapping portion of the angles of view, and can output a wide-range image at once.

### Second Embodiment

Next, the distance image capturing system 1 according to the second embodiment will be described with reference to the accompanying drawings. In the present embodiment, for example, a corresponding modification example will be described in a case where the pixel value is saturated or in a case where there is an object (target object) near the TOF camera 10 in the overlapping region OA3.

Since a hardware configuration of the distance image capturing system 1 according to the present embodiment is the same as that in the first embodiment shown in FIGS. 1 and 2, description thereof will be omitted here.

In the present embodiment, the synthesis processing of the synthesis processing unit 41 of the control device 40 is different from that in the first embodiment, and the synthesis processing of the synthesis processing unit 41 will be described here.

In a case where the pixel value of the selected pixel exceeds a predetermined threshold value (for example, a saturation value), the synthesis processing unit 41 according to the present embodiment selects a pixel having the largest pixel value from among pixels having pixel values equal to or less than the threshold value. That is, in a case where images are synthesized by the two TOF cameras 10, the synthesis processing unit 41 compares the pixel values of the respective pixels, selects a pixel having a larger pixel value, and further selects the other pixel that is not saturated in a case where the pixel value exceeds a predetermined threshold value (for example, a saturation value).

In addition, in a case where the selected pixel value exceeds a predetermined threshold value (for example, a saturation value), the synthesis processing unit 41 further invalidates the pixel.

As in the first embodiment, the synthesis processing unit 41 synthesizes the IR images using the pixel value of the selected pixel in consideration of the saturation of the pixel values in the overlapping region (overlapping region OA3).

In addition, in the overlapping region (overlapping region OA3), the synthesis processing unit 41 compares the distances of the overlapping pixels and synthesizes the distance images using the shortest distance. The synthesis processing unit 41 calculates, for example, a distance to a point at which the angles of view of the plurality of TOF cameras 10 overlap each other in the overlapping region (overlapping region OA3), and synthesizes the distance images by prioritizing the pixel having a shorter distance in a case where an object exists before the point at which the angles of view overlap each other.

Next, the details of the synthesis processing of the synthesis processing unit 41 in the present embodiment will be described with reference to the accompanying drawings.

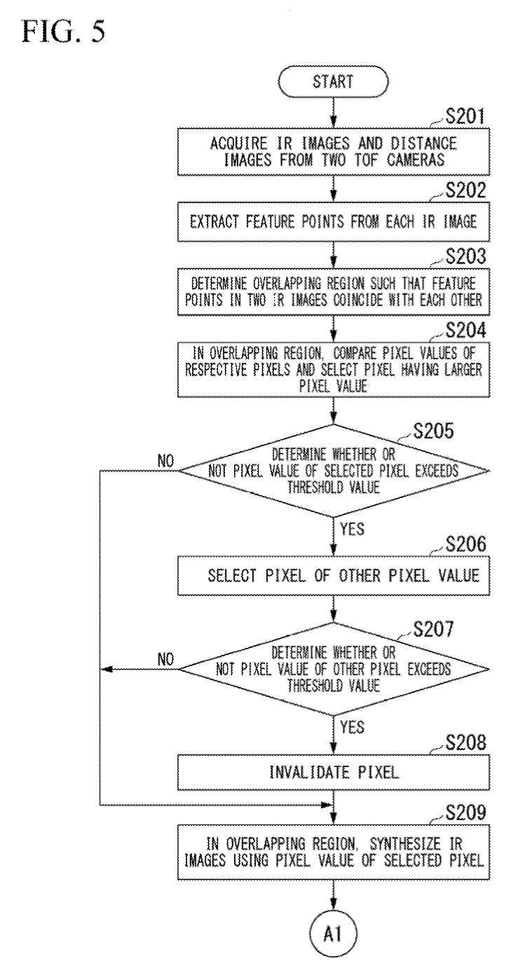

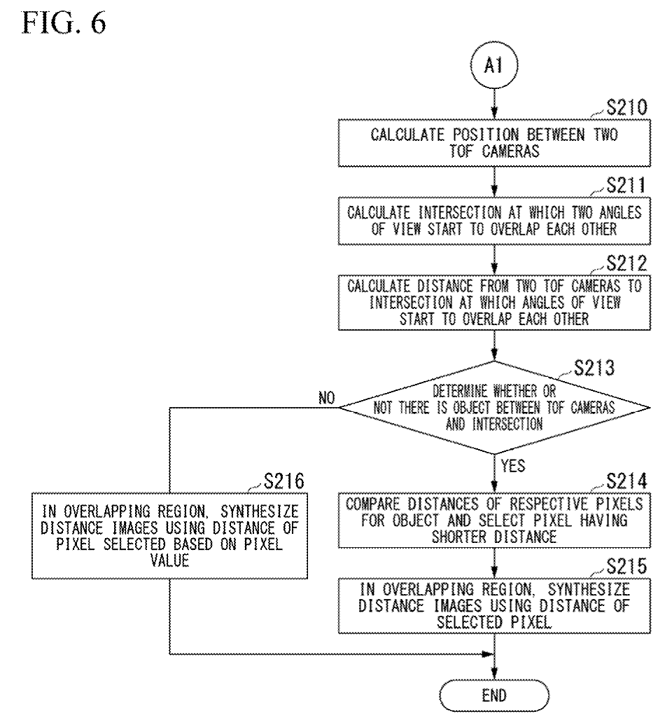

FIGS. 5 and 6 are flowcharts showing an example of the image synthesis processing of the distance image capturing system 1 according to the present embodiment.

In FIG. 5, the processing from step S201 to step S204 is the same as the processing from step S101 to step S104 shown in FIG. 4 described above, and thus description thereof will be omitted here.

In step S205, the synthesis processing unit 41 determines whether or not the pixel value of the selected pixel exceeds a threshold value (for example, a saturation value). In a case where the pixel value of the selected pixel exceeds the threshold value (for example, the saturation value) (step S205: YES), the synthesis processing unit 41 advances the processing to step S206. In addition, in a case where the pixel value of the selected pixel is equal to or less than the threshold value (for example, the saturation value) (step S205: NO), the synthesis processing unit 41 advances the processing to step S209.

In step S206, the synthesis processing unit 41 selects the pixel having the other pixel value. In a case where three or more IR images are synthesized, the synthesis processing unit 41 selects a pixel having a pixel value that is not saturated (equal to or less than the threshold value) and that has the next largest pixel value.

Next, the synthesis processing unit 41 determines whether or not the pixel value of the other pixel exceeds the threshold value (for example, the saturation value) (step S207). In a case where the pixel value of the other pixel exceeds the threshold value (for example, the saturation value) (step S207: YES), the synthesis processing unit 41 advances the processing to step S208. In addition, in a case where the pixel value of the other pixel is equal to or less than the threshold value (for example, the saturation value) (step S207: NO), the synthesis processing unit 41 advances the processing to step S209.

In step S208, the synthesis processing unit 41 invalidates the pixel.

Then, in step S209, the synthesis processing unit 41 synthesizes the IR images using the pixel value of the selected pixel in the overlapping region OA3. The synthesis processing unit 41 synthesizes the IR images using the pixel value of the selected pixel to generate, for example, the composite IR image synthesized in the range of the angle of view OA1 and the angle of view OA2.

Then, as shown in FIG. 6, the synthesis processing unit 41 calculates the position between the two TOF cameras 10 (step S210). For example, as shown in FIG. 1, the TOF camera 10-1 and the TOF camera 10-2 are arranged in parallel, and the synthesis processing unit 41 calculates how far the two TOF cameras 10 are from each other. For example, the synthesis processing unit 41 calculates a position between the two TOF cameras 10 by using a method employing triangulation based on distances acquired by the respective TOF cameras 10 when measuring a target, or by fixing the TOF cameras 10 and making their positions known.

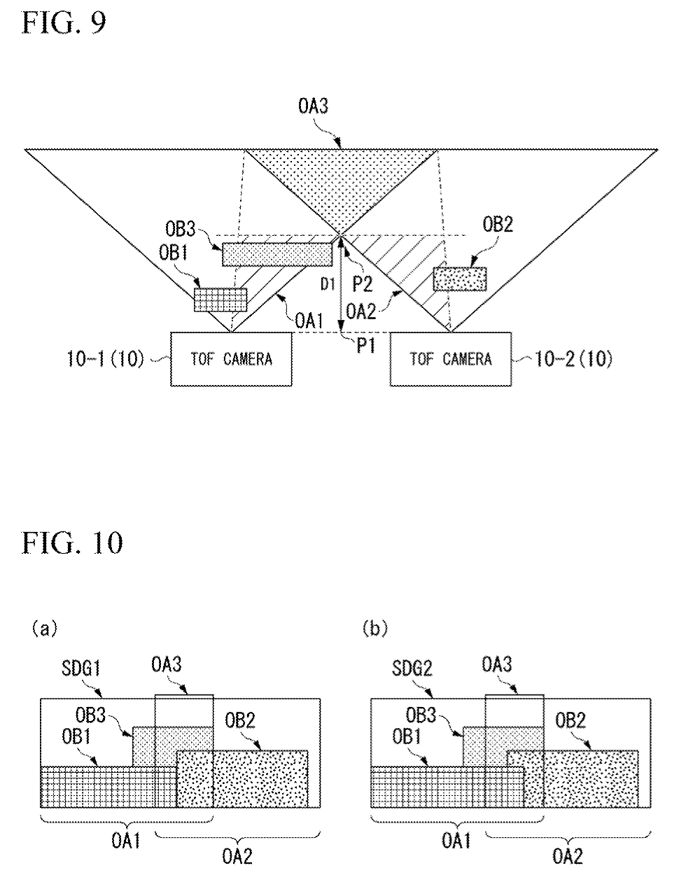

Next, the synthesis processing unit 41 calculates an intersection at which the two angles of view (angle of view OA1 and angle of view OA2) start to overlap each other (step S211). The synthesis processing unit 41 calculates an angle-of-view overlap start point (intersection P2 in FIG. 9 described later) from the distance between the TOF cameras 10, the known angle of view OA1 of the TOF camera 10-1, and the known angle of view OA2 of the TOF camera 10-2.

Next, the synthesis processing unit 41 calculates the distance (distance D1 in FIG. 9 described later) to the intersection (intersection P2 in FIG. 9 described later) at which the angles of view from the two TOF cameras 10 start to overlap each other (step S212).

Next, the synthesis processing unit 41 determines whether or not there is an object between the TOF camera 10 and the intersection (intersection P2) (step S213). In a case where there is an object between the TOF camera 10 and the intersection (intersection P2) (step S213: YES), the synthesis processing unit 41 advances the process to step S214. Further, in a case where there is no object between the TOF camera 10 and the intersection (intersection P2) (step S213: NO), the synthesis processing unit 41 advances the process to step S216.

In step S214, the synthesis processing unit 41 compares the distances of the respective pixels in the object, and selects the pixel having the shorter distance.

Then, the synthesis processing unit 41 synthesizes the distance images using the distance of the selected pixel in the overlapping region OA3 (step S215). The synthesis processing unit 41 synthesizes the distance images of the overlapping region OA3 using the pixel having a shorter distance of the object, and generates, for example, the composite distance image synthesized in the range of the angle of view OA1 and the angle of view OA2. After the processing in step S215, the synthesis processing unit 41 ends the processing.

Further, in step S216, the synthesis processing unit 41 synthesizes the distance images using the distance of the pixel selected by the pixel value in the overlapping region OA3. The synthesis processing unit 41 synthesizes the distance images using the distance of the selected pixel to generate, for example, the composite distance image synthesized in the range of the angle of view OA1 and the angle of view OA2. After the processing in step S216, the synthesis processing unit 41 ends the processing.

In step S216, in a case where there is no object within the range of the angle of view OA1 and the angle of view OA2, and the distance value cannot be extracted, the synthesis processing unit 41 may execute processing of filling the distance value with an appropriate value without performing the synthesis.

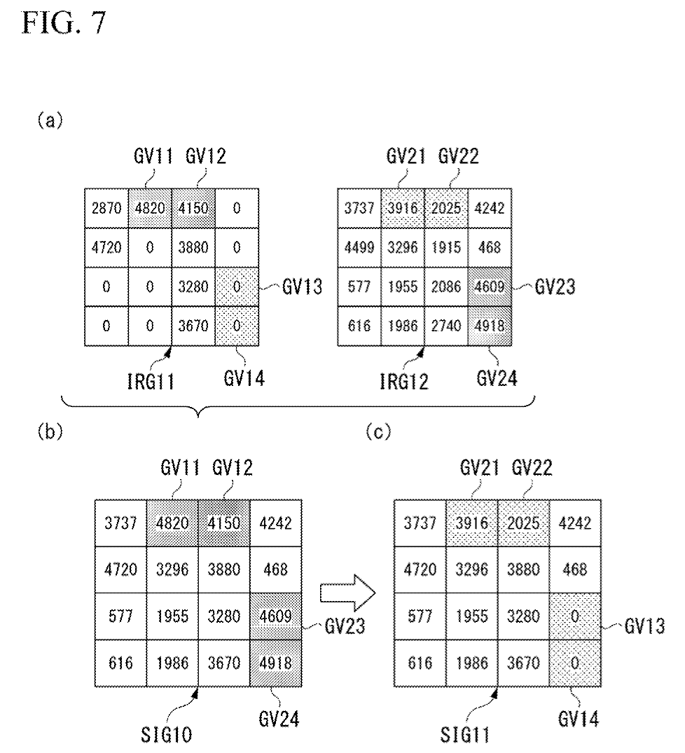

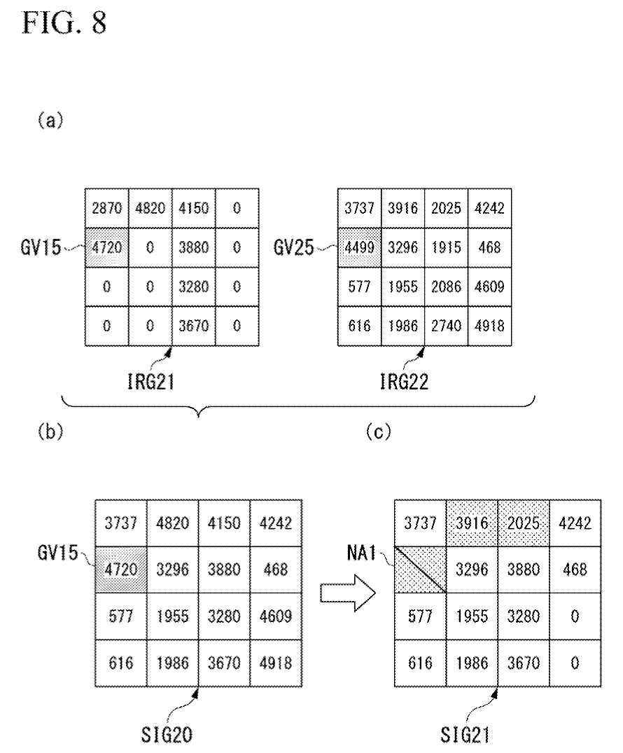

Next, exception processing in the image synthesis processing of the IR images of the distance image capturing system 1 according to the present embodiment will be described with reference to FIGS. 7 and 8.

FIGS. 7 and 8 show an example of the exception processing in the image synthesis processing of the IR images of the distance image capturing system 1 according to the present embodiment.

In (a) of FIG. 7, an IR image IRG11 is an overlapping region (overlapping region OA3) of the IR image captured by the TOF camera 10-1. Further, an IR image IRG12 is an overlapping region (overlapping region OA3) of the IR image captured by the TOF camera 10-2.

In the IR image IRG11, the pixel values of a pixel GV11 and a pixel GV12 exceed the saturation value, and the pixel values of a pixel GV13 and a pixel GV14 are normal values equal to or less than the saturation value. Further, in the IR image IRG12, the pixel values of a pixel GV23 and a pixel GV24 exceed the saturation value, and the pixel values of a pixel GV21 and a pixel GV22 are normal values equal to or less than the saturation value.

Further, in (b) of FIG. 7, an IR image SIG10 of the selected pixel shows an IR image in which a larger value is selected by comparing the pixel values of the IR image IRG11 and the IR image IRG12 in the overlapping region OA3. In such a case, the pixel GV11 and the pixel GV12 and the pixel GV23 and the pixel GV24, which are pixels exceeding the saturation value, are selected in the IR image SIG10 of the selected pixel. That is, the IR image SIG10 of the selected pixel shown in (b) of FIG. 7 shows a state in which the processing up to step S204 shown in FIG. 5 is executed.

Next, (c) of FIG. 7 shows an example in which processing of excluding a pixel exceeding the saturation value is performed as the exception processing. In (c) of FIG. 7, an IR image SIG11 of the selected pixel shows that the other pixel is selected for the pixel exceeding the saturation value, and the pixel GV13 and the pixel GV14, and the pixel GV21 and the pixel GV22 are selected. That is, the IR image SIG11 of the selected pixel shown in (c) of FIG. 7 shows a state in which the processing up to step S206 shown in FIG. 5 is executed.

In this way, the synthesis processing unit 41 in the present embodiment selects the other pixel in a case where the pixel value of the selected pixel exceeds the saturation value.

In addition, in (a) of FIG. 8, an IR image IRG21 is an overlapping region (overlapping region OA3) of the IR image captured by the TOF camera 10-1. Further, an IR image IRG22 is an overlapping region (overlapping region OA3) of the IR image captured by the TOF camera 10-2.

In the IR image IRG21, the pixel value of the pixel GV15 exceeds the saturation value. Further, in the IR image IRG22, the pixel value of the pixel GV25 exceeds the saturation value. That is, the example shown in FIG. 8 shows a case where both the pixel values compared with each other exceed the saturation value.

In this case, as shown in (b) of FIG. 8, the IR image SIG20 of the selected pixel in step S204 of FIG. 5 is the pixel GV15 in the overlapping region OA3, but the pixel value of the pixel GV15 exceeds the saturation value, so that the selected pixel is invalidated (invalidated pixel NA1) in step S208 of FIG. 5 as in the IR image SIG21 of the selected pixel shown in (c) of FIG. 8.

In this way, the synthesis processing unit 41 in the present embodiment invalidates the selected pixel in a case where the pixel value of the selected pixel exceeds the saturation value and the pixel value of the other pixel exceeds the saturation value.

Hereinafter, a specific example of the image synthesis processing of the distance image of the distance image capturing system 1 according to the present embodiment will be described with reference to FIGS. 9 and 10.

In FIG. 9, the intersection P2 indicates an intersection at which the two angles of view (angle of view OA1 and angle of view OA2) start to overlap each other, and the distance between the TOF camera 10 and the intersection P2 is a distance D1.

In addition, the example shown in FIG. 9 shows a case where an object OB1, an object OB2, and an object OB3 are present between the TOF camera 10 and the intersection P2.

The distances of the object OB1, the object OB2, and the object OB3 are, in order from closest to the TOF camera 10, the object OB1, the object OB2, and the object OB3.

In the case shown in FIG. 9, the synthesis processing unit 41 preferentially selects a pixel having a shorter distance in the overlapping region OA3, and synthesizes the distance images using the distance of the selected pixel.

(a) of FIG. 10 shows an example of a case where the pixels are selected using only the pixel value of the IR image and the distance images are synthesized in the case shown in FIG. 9.

In the example shown in (a) of FIG. 10, since the pixel value is selected based on the reflectances of the object OB1, the object OB2, and the object OB3, and the distance images are synthesized, a distance relationship of the composite distance image may be abnormal. In a composite distance image SDG1 shown in (a) of FIG. 10, a positional relationship between the object OB2 and the object OB1 is abnormal in the overlapping region OA3.

On the other hand, the example shown in (b) of FIG. 10 shows an example in which the synthesis processing unit 41 in the present embodiment compares the distances, selects the pixel, and synthesizes the distance images. In the composite distance image SDG2 shown in (b) of FIG. 10, a distance image in which the distance relationship between the object OB1, the object OB2, and the object OB3 is normal is generated in the overlapping region OA3.

As described above, in the present embodiment, in a case where the pixel value of the selected pixel exceeds a predetermined threshold value (for example, a saturation value), the synthesis processing unit 41 selects a pixel having the largest pixel value from among pixels having pixel values equal to or less than the threshold value. That is, in a case of the two TOF cameras 10, the synthesis processing unit 41 selects the other pixel in a case where the pixel value of the selected pixel exceeds a predetermined threshold value (for example, a saturation value).

As a result, the distance image capturing system 1 according to the present embodiment excludes, from pixels used for synthesis, a pixel in which the distance cannot be normally measured and which has a pixel value exceeding a threshold value (for example, a saturation value), and thus can output a more optimal distance image of an overlapping portion of the angle of view and can output a wide-range image at once.

In addition, in the present embodiment, the synthesis processing unit 41 synthesizes the optical images using the pixel value of the selected pixel in the overlapping region (overlapping region OA3), and synthesizes the distance images using the pixel having the shortest distance by comparing the distances of the overlapping pixels in the overlapping region (overlapping region OA3).

As a result, the distance image capturing system 1 according to the present embodiment can further synthesize a distance image in which the distance relationship is accurate in the overlapping region (overlapping region OA3). That is, in the distance image capturing system 1 according to the present embodiment, the object close to the TOF camera 10 is preferentially synthesized in the overlapping region OA3, so that it is possible to reduce the occurrence of a composite image in which the distance relationship is unnatural.

In addition, in the present embodiment, the synthesis processing unit 41 synthesizes the IR images using the pixel value of the selected pixel in the overlapping region (overlapping region OA3), calculates the distance to the point (intersection P2) at which the angles of view of the plurality of TOF cameras 10 overlap each other in the overlapping region (overlapping region OA3), and synthesizes the distance images using the pixel having the shortest distance (selecting the pixels having a shorter distance) in a case where an object is present between the point (intersection P2) at which the angles of view overlap each other.

As a result, the distance image capturing system 1 according to the present embodiment limits the case of selecting the pixels by the distance using the point (intersection P2) at which the angles of view overlap each other, and thus can further synthesize a distance image in which the distance relationship is accurate in the overlapping region (overlapping region OA3).

The present invention is not limited to the above embodiments, and can be changed without departing from the gist of the present invention.

For example, in each of the above embodiments, the example has been described in which the distance image capturing system 1 includes the two TOF cameras 10, but the present invention is not limited thereto, and three or more TOF cameras 10 may be provided.

In addition, in each of the above embodiments, the example has been described in which the angles of view of the plurality of TOF cameras 10 are expanded in the lateral direction (horizontal direction), but the present invention is not limited thereto, and the angles of view may be expanded in the longitudinal direction (vertical direction).

In addition, in each of the above embodiments, the example has been described in which the overlapping region OA3 is a region in which the angles of view of the two TOF cameras 10 overlap each other, but the present invention is not limited thereto, and the angles of view of three or more TOF cameras 10 may overlap each other.

In addition, in each of the above embodiments, the example has been described in which the distance between the two TOF cameras 10 is calculated on the premise that the positional relationship between the two TOF cameras 10 is unknown, but the present invention is not limited thereto, and the positional relationship between the two TOF cameras 10 may be fixed in advance. In this case, the calculation processing of the distance between the two TOF cameras 10 is not required, and thus the processing can be simplified.

In addition, the example has been described in which the two TOF cameras 10 are arranged in parallel, but the present invention is not limited thereto, and the two TOF cameras 10 may be arranged with an angle provided in the angles of view.

In addition, in each of the above embodiments, the example has been described in which the pixels used for the image synthesis are selected by prioritizing the pixel value of the IR image in the overlapping region OA3, but the present invention is not limited thereto, and the pixels used for the image synthesis may be selected by prioritizing the distance of the distance image. For example, the synthesis processing unit 41 may select the pixels used for the image synthesis by comparing the distances of the pixels of the distance image without using the pixel value of the IR image.

In addition, in each of the above embodiments, the example has been described in which the control device 40 is a computer device such as a personal computer, but the present invention is not limited thereto, and, for example, in a case where the distance image capturing system 1 is incorporated in a robot, another configuration may be adopted, such as a configuration in which a control unit of the robot includes the synthesis processing unit 41.

Further, the synthesis processing unit 41 may be provided in a server device on a network, such as a cloud server, and the image synthesis processing may be executed by the server device.

Each component included in the distance image capturing system 1 described above has a computer system therein. A program for implementing the functions of each component included in the distance image capturing system 1 may be recorded on a computer-readable recording medium, and the program recorded on the recording medium may be read into the computer system and executed to perform the processing in each component included in the distance image capturing system 1. Here, the expression "the program recorded on the recording medium is read into the computer system and executed" includes that the program is installed in the computer system. The term "computer system" includes an OS or hardware such as peripheral devices.

The "computer system" may include a plurality of computer devices connected via a network including a communication line such as the Internet, a WAN, a LAN, or a dedicated line. The term "computer-readable recording medium" refers to a portable medium such as a flexible disk, a magneto-optical disk, a ROM, or a CD-ROM, or a storage device such as a hard disk built in the computer system. In this way, the recording medium in which the program is stored may be a non-transitory recording medium such as a CD-ROM.

Further, the recording medium also includes a recording medium provided inside or outside that is accessible from a distribution server for distributing the program. The program may be divided into a plurality of programs and downloaded at different timings, and thereafter be combined by respective components included in the distance image capturing system 1, or distribution servers that distribute the respective divided programs may be different. Furthermore, the term "computer-readable recording medium" also includes a medium that holds the program for a certain period, such as a volatile memory (RAM) inside a computer system that is a server or a client when the program is transmitted via a network. In addition, the above program may be a program for implementing a part of the above functions. Furthermore, the program may be a so-called difference file (difference program) that can implement the above-described functions in combination with a program that has already been recorded in the computer system.

In addition, a part or all of the above functions may be achieved as an integrated circuit such as a large scale integration (LSI). Each of the above functions may be individually implemented as a processor, or a part or all of the above functions may be integrated and implemented as a processor. In addition, the method of circuit integration is not limited to LSI, and may be implemented by a dedicated circuit or a general-purpose processor. Further, when an integrated-circuit technology that substitutes for the LSI emerges as a result of advances in semiconductor technology, an integrated circuit based on that technology may be used.

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

### EXPLANATION OF REFERENCES

1: distance image capturing system
2: light source unit
3: light receiving unit
4: image processing unit
10, 10-1, 10-2: TOF camera
21: light source device
22: diffusion plate
31: lens
32: distance image sensor (distance image capturing element)
40: control device
41: synthesis processing unit
321: pixel array
322: pixel drive circuit

What is claimed is:

1. A distance image capturing system comprising:
a plurality of distance image capturing devices arranged such that angles of view thereof partially overlap each other, each of the plurality of distance image capturing devices including a light source unit configured to irradiate a subject with optical pulses, and a light receiving unit in which a plurality of pixels are arranged, each of the pixels having a photoelectric conversion element configured to generate a charge in accordance with reflected light of the optical pulses from the subject, each of the plurality of distance image capturing devices being configured to output optical images based on pixel values that are values of the pixels based on the charges, and distance images calculated based on a period from irradiation with the optical pulses to reception of the reflected light; and
a synthesis processing unit configured to synthesize the optical images and the distance images output from the plurality of distance image capturing devices,
wherein the synthesis processing unit is configured to compare pixel values of overlapping pixels in an overlapping region in which the angles of view partially overlap each other, select a pixel having a pixel value estimated to be optimal, and perform synthesis using a value based on the selected pixel.

2. The distance image capturing system according to claim 1,
wherein the synthesis processing unit is configured to compare the pixel values of the overlapping pixels, and select a pixel having a largest pixel value as the pixel having the pixel value estimated to be optimal.

3. The distance image capturing system according to claim 2,
wherein the synthesis processing unit is configured to select, when a pixel value of the selected pixel exceeds a predetermined threshold value, a pixel having a largest pixel value from among pixels having pixel values equal to or less than the threshold value.

4. The distance image capturing system according to claim 3,
wherein the synthesis processing unit is configured to, in the overlapping region, synthesize the optical images using the pixel value of the selected pixel and synthesize the distance images using a distance indicated by the selected pixel.

5. The distance image capturing system according to claim 3,
wherein the synthesis processing unit is configured to
synthesize the optical images using the pixel value of the selected pixel in the overlapping region, and
synthesize the distance images using a pixel having a shortest distance by comparing distances of the overlapping pixels in the overlapping region.

6. The distance image capturing system according to claim 5,
wherein the synthesis processing unit is configured to
synthesize the optical images using the pixel value of the selected pixel in the overlapping region, and
calculate a distance to a point at which the angles of view of the plurality of distance image capturing devices overlap each other in the overlapping region, and, when an object exists before the point at which the angles of view overlap each other, synthesize the distance images using the pixel having the shortest distance.

7. The distance image capturing system according to claim 1,
wherein the synthesis processing unit is configured to extract feature points from the optical images output from the plurality of distance image capturing devices, and determine synthesis positions of the optical images such that the extracted feature points coincide with each other.

8. The distance image capturing system according to claim 7,
wherein the overlapping region in which the angles of view partially overlap each other is a region in which angles of view of two distance image capturing devices partially overlap each other.

9. A distance image capturing method comprising:
an imaging step of, via a plurality of distance image capturing devices arranged such that angles of view thereof partially overlap each other, each of the plurality of distance image capturing devices including a light source unit configured to irradiate a subject with optical pulses, and a light receiving unit in which a plurality of pixels are arranged, each of the pixels having a photoelectric conversion element configured to generate a charge in accordance with reflected light of the optical pulses from the subject, outputting optical images based on pixel values that are values of the pixels based on the charges, and distance images calculated based on a period from irradiation with the optical pulses to reception of the reflected light; and
a synthesis processing step of, via a synthesis processing unit, synthesizing the optical images and the distance images output from the plurality of distance image capturing devices,
wherein, in the synthesis processing step, the synthesis processing unit compares pixel values of overlapping pixels in an overlapping region in which the angles of view partially overlap each other, selects a pixel having a pixel value estimated to be optimal, and performs synthesis using a value of the selected pixel.

10. A distance image capturing system comprising:
a plurality of distance image capturing devices arranged such that angles of view thereof partially overlap each other, each of the plurality of distance image capturing devices including a light source unit configured to irradiate a subject with optical pulses, and a light receiving unit in which a plurality of pixels are arranged, each of the pixels having a photoelectric conversion element configured to generate a charge in accordance with reflected light of the optical pulses from the subject, each of the plurality of distance image capturing devices being configured to output optical images based on pixel values that are values of the pixels based on the charges, and distance images calculated based on a period from irradiation with the optical pulses to reception of the reflected light; and
a synthesis processing unit configured to synthesize the optical images and the distance images output from the plurality of distance image capturing devices,
wherein the synthesis processing unit is configured to extract feature points from the optical images output from the plurality of distance image capturing devices, and determine synthesis positions of the optical images such that the extracted feature points coincide with each other,
the synthesis processing unit is configured to compare pixel values of overlapping pixels in an overlapping region in which the angles of view partially overlap each other, select a pixel having a pixel value estimated to be optimal, and perform synthesis using a value based on the selected pixel, and
the synthesis processing unit is configured to compare the pixel values of the overlapping pixels, and select a pixel having a largest pixel value as the pixel having the pixel value estimated to be optimal.
